(19) United States
(12) Patent Application Publication
(10) Pub. No.: US 2009/0094594 A1
(43) Pub. Date: Apr. 9, 2009

(54) BLADE-BASED MODULAR SYSTEM FOR SUPPORTING APPLICATION SPECIFIC FUNCTIONS

(75) Inventor: Anthony B. Walker, Woodstock, CT (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: ORTRONICS, INC., New London, CT (US)

(21) Appl. No.: 11/866,664

(22) Filed: Oct. 3, 2007

(51) Int. Cl. G06F 15/173; G06F 15/80; G06F 9/445; G06F 9/06

(52) U.S. Cl. 717/174; 712/28; 709/224; 712/E09.003

(57) ABSTRACT

Blade-based systems and methods are provided that support a plurality of application-specific functions associated with data processing, communication and/or storage. Exemplary embodiments include a chassis for receipt of a plurality of blades. The blades are programmed/loaded with application-specific software, e.g., wireless communication software, that facilitates data-related operations. The chassis may also contain cooling vents, power supply modules and/or circuitry, and a backplane for requisite communications. Additional structural features and components may include mounting brackets, cooling/exhaust fans and detachable front/rear faces to facilitate mounting and/or service of associated components. The design and operation of the blade-based system and method offer significant advantages to entities involved in the manufacture, installation, maintenance and/or use of hardware and software applications by unifying the hardware and application software in a cost effective, reliable and efficient modular assembly.

### BACKGROUND

1. Technical Field

The present disclosure is directed to blade-based, modular systems and methods that support one or more application-specific functions. More particularly, the present disclosure is directed to systems and methods that employ blade-based server technology to drive/control application-specific functions, e.g., wireless communications, in a modular fashion.

2. Background Art

As data storage, data communication and related network systems and architectures have advanced and expanded, hardware and software developers and manufacturers have worked to streamline the design and operation of their products and services. In network communications, servers or application devices have long provided the backbone for network design and operation. Thus, in conventional client/server networks, one or more central computers, i.e., servers, generally support many aspects of network operation. For example, a server generally contains programs and data files that can be accessed by other computers in or on the network. Servers typically run network operating systems, e.g., Windows NT, Unix, Linux or the like, which facilitates file movement, computer communication, network security and other system operations.

Beyond managing network communications, servers are also provided that service specific, specialized functions. For example, print servers facilitate printer operation on a network, thereby permitting multiple network users to interact with one or more shared printers. Similarly, specialized servers may be provided that facilitate access to the Internet, data storage drives, tape backup and the like. Still further, servers are provided that support operation of specialized programs/applications on a shared basis, e.g., across a network. Exemplary servers of this type include email servers and database servers.

The degree to which network-connected computers interact with and rely upon servers varies from system to system. Computers that are attached to or in communication with a server are generally referred to as clients. In some instances, the client computer is capable of running most programs from its own hard drive, using minimum network services/support. Such clients are frequently referred to as “fat clients.” In other instances, the client computer require significant network service/support. Such “thin clients” are generally able to run programs and graphics using their own microprocessor, but depend on an associated server to run programs, store data files, and the like. “Dumb terminals,” in turn, generally include only keyboard and monitor, relying on associated server(s) to perform any and all functions.

In today's market, servers/application devices are traditionally stand alone pieces of equipment that are designed and manufactured (or sourced) by an application development entity. Thus, for example, a company specializing in wireless communications generally designs and manufactures (or sources) requisite servers/application devices, e.g., wireless controller switches. The industry has also developed such that frequently the specialized entity also designs and develops the software/programming/firmware required to operate both the hardware and the application software. In this way, the specialized entity maximizes both its revenues and control over product design, operation and performance.

A further segment of today's market involves blade servers. A blade server is essentially a housing for a number of individual minimally-packaged computer motherboard “blades”, each including one or more processors, memory, storage, and network connections, but sharing the common power supply and air-cooling resources of the chassis. Each blade is a server in its own right, often dedicated to a single application. Generally, blade servers allow more processing power in less rack space, simplifying cabling and reducing power consumption.

Each blade typically comes with one or two local ATA or SCSI drives. For additional storage, blade servers can connect to a storage pool facilitated by a network-attached storage (NAS), fiber channel, or iSCSI storage-area network (SAN). The advantage of blade servers comes not only from the consolidation benefits of housing several servers in a single chassis, but also from the consolidation of associated resources (like storage and networking equipment) into a smaller architecture that can be managed through a single interface. Blade servers find particular applicability where clustered servers are dedicated to a single task, such as file sharing, web page serving and caching, SSL encrypting of Web communication, transcoding of Web page content for smaller displays, streaming audio and video content, and the like. Blade servers are frequently adapted to include load balancing and failover capabilities among and between individual blades.

Despite efforts to date, a need remains to improve the flexibility and efficiency of hardware and software system design, manufacture and implementation for data storage, data communication and related network system applications. These and other needs are satisfied according to the present disclosure.

### SUMMARY

The present disclosure provides blade-based, modular systems and methods that support one or more application-specific functions associated with data processing, communication and/or storage. The disclosed systems and methods employ blade-based server technology to manage, drive and/or control application-specific functions, e.g., wireless communications, in a modular fashion. The design and operation of the disclosed systems/methods offer significant advantages to individuals/entities involved in the manufacture, installation, maintenance and/or use of hardware and software applications by unifying the hardware and application software in a cost effective, reliable and efficient modular assembly/system.

Exemplary embodiments of the disclosed system/assembly generally includes a chassis that defines an internal space for receipt of a plurality of blades. The chassis also contains and/or supports conventional blade-related operations. Thus, for example, the chassis generally includes and/or interacts with one or more cooling vents/cooling components, power supply modules and/or power sources, and/or communication-related circuitry/grounding. The chassis may also include a backplane (or laterally-located plane(s)) for positioning of requisite connections, components or the like. Additional structural features and components associated with the disclosed chassis may include mounting brackets, cooling/exhaust fans and detachable front/rear faces to facilitate mounting and/or service of associated components.

Unlike conventional blade-based assemblies that are limited in operation/application to generic operations, e.g., storage/database applications (e.g., SAP, Oracle and the like) or enterprise application software (e.g., MRP, ERP, CRM and the like), the disclosed systems and methods provide and support blades that are programmed/loaded with application-specific software such that an integrated/consolidated blade-based resource is supplied in a convenient, efficient and cost-effective manner. More specifically, individual blades that are integrated or consolidated into the disclosed assembly are typically programmed with a variety of application-specific software/programming/firmware, e.g., wireless communication software, network admission control (NAC) software, radio frequency identification (RFID) software, spectrum analysis software, and combinations thereof.

Thus, the present disclosure provides a unified and integrated solution that permits manufacturers, suppliers, installers, maintenance support, and users to consolidate their needs in a single, cost-effective modular assembly. The assembly is configured and dimensioned to require limited space, minimize energy needs/use, and control heat generation in an efficient and unified manner. Additional features, functions and benefits of the disclosed systems and methods will be apparent from the detailed description which follows, particularly when read in conjunction with the appended figures.

### BRIEF DESCRIPTION OF THE FIGURES

To assist those of ordinary skill in the art in making and using the disclosed blade-based systems and methods, reference is made to the accompanying figures, wherein:

FIG. 1A is a front view of an exemplary blade-based assembly according to the present disclosure;

FIG. 1B is a front view of an alternative exemplary blade-based assembly according to the present disclosure;

FIG. 2 is a perspective rear view of an exemplary blade-based assembly of the type depicted in FIGS. 1A and 1B;

FIG. 3 is a front view of the exemplary blade-based assembly of FIGS. 1A, 1B and 2, with blades removed; and

FIG. 4 is a front perspective view of the exemplary blade-based assembly of the preceding figures with blades and front face removed.

### DESCRIPTION OF EXEMPLARY EMBODIMENT(S)

The present disclosure provides blade-based, modular systems and methods that support one or more application-specific functions associated with data processing, communication and/or storage. The disclosed systems and methods support an advantageous integrated and modular approach to managing, driving and/or controlling application-specific functions, e.g., wireless communications. Individual blades incorporated into the integrated assembly are programmed/loaded with application-specific software such that an integrated/consolidated blade-based resource is supplied to installers/end users in a convenient, efficient and cost-effective manner. Exemplary application-specific software, programming and/or firmware that may be incorporated onto the modular blades associated with the disclosed assembly include wireless application software, network admission control (NAC) software, radio frequency identification (RFID) software, spectrum analysis software, and combinations thereof.

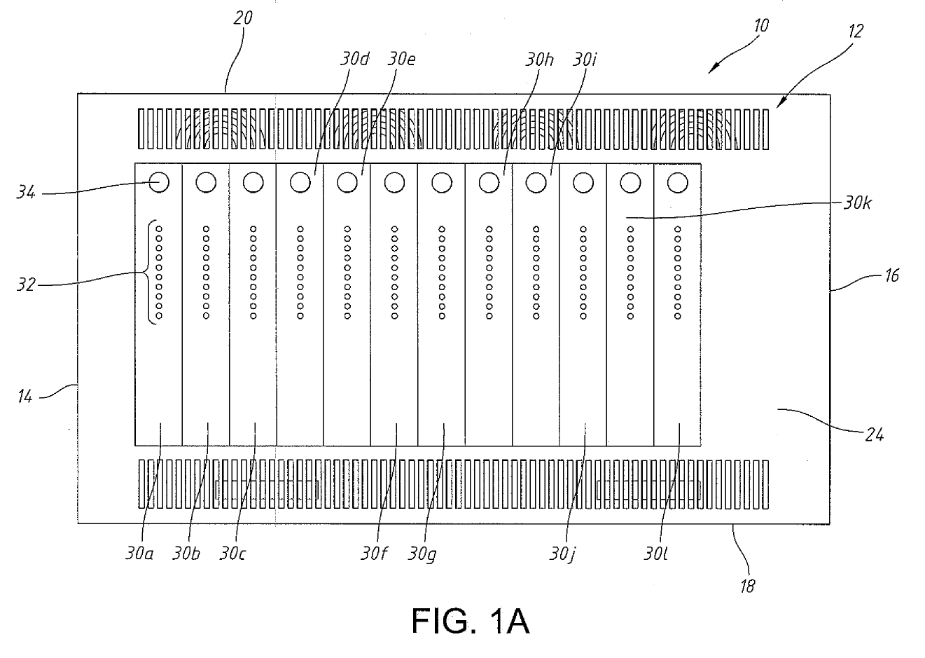

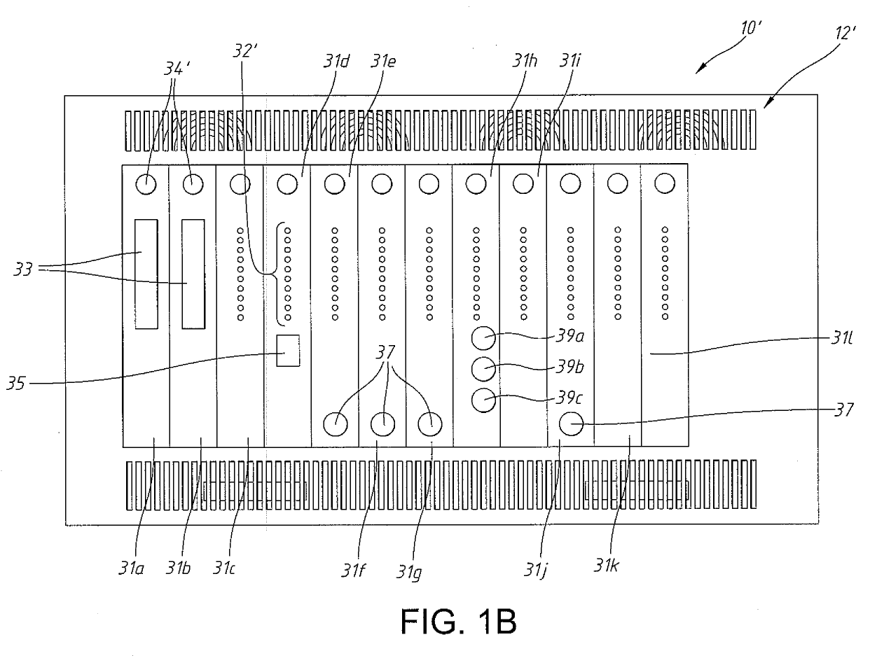

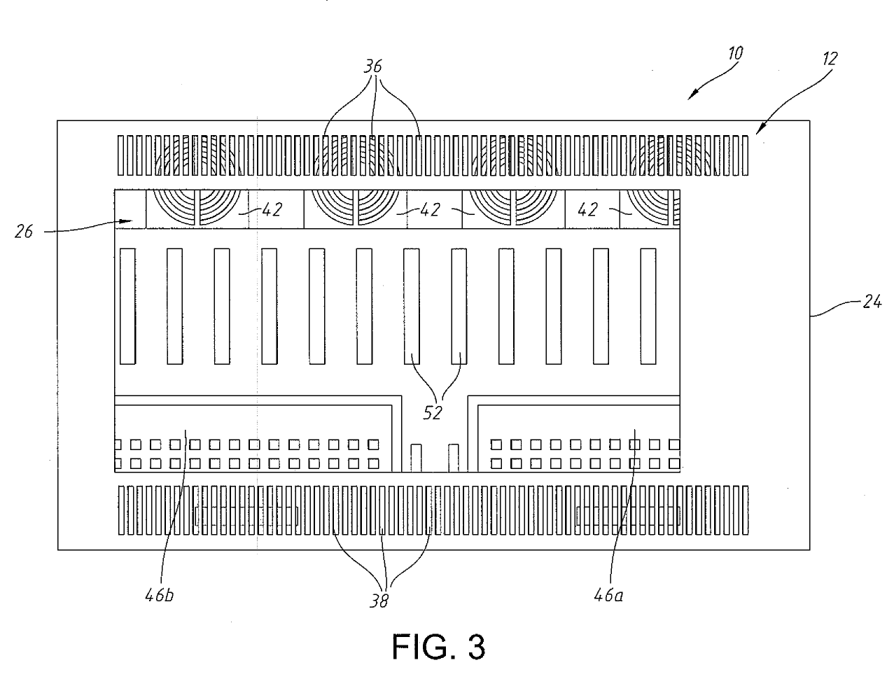

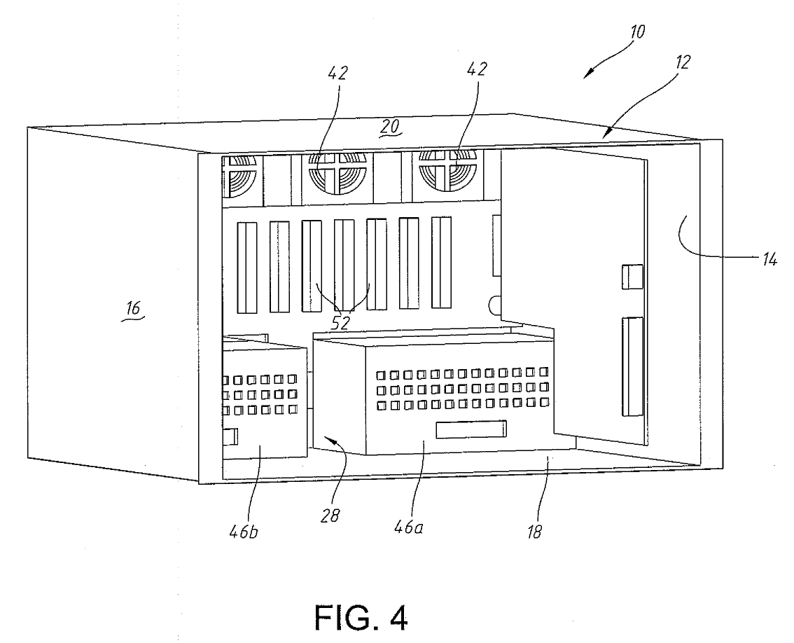

Turning to FIGS. 1A and 2-4, an exemplary assembly 10 according to the present disclosure is schematically depicted. Assembly 10 includes a chassis 12 that is defined by side faces 14, 16, base 18, top face 20 and rear wall 22. Front face 24 is detachably mounted with respect to side faces 14, 16 (e.g., with screws, bolts or the like; not pictured). Front face 24 defines a substantially rectangular opening 26 (FIG. 3) that facilitates viewing of and interaction with the contents of chassis 12. Chassis 12 defines an interior region 28 (FIG. 4) that is bounded by base 18, faces 14, 16 and 20, and front face 24 (when attached thereto). Interior region 28 is configured and dimensioned to receive, inter alia, a plurality of blades 30a-30l.

With particular reference to FIG. 1A, assembly 10 is depicted with twelve (12) blades 30a-30l mounted with respect to chassis 12. While the exemplary assembly 10 of FIGS. 1A and 2-4 includes twelve (12) blades, the present disclosure is not limited by or to the precise number of blades depicted therein. Rather, the disclosed assembly may be configured and dimensioned to accommodate virtually any number of blades, subject only to considerations such as power, space, heat and the like. Thus, the disclosed assembly may be configured and dimensioned to receive as few as two blades and as many as several dozen, without departing from the spirit or scope hereof.

Blades 30a-30l are typically mounted in a vertical orientation, such that a series of blades may be positioned in a side-by-side orientation while limiting space/rack requirement associated with multiple blades. However, the present disclosure further encompasses implementations wherein individual blades are mounted in a horizontal orientation, i.e., blades are positioned one above the next. Once positioned in interior region 26, front face 24 is generally secured to other aspects of chassis 12, e.g., side faces 14, 16, so as to secure blades 30a-30l therewithin. As is known in the art, blades 30a-30l may include indicator LEDs 32 and a power button 34 on an accessible face thereof. LEDs 32 are generally adapted to signal operational activities associated with the blade, e.g., the receipt of a communication, data processing, and/or transmission of a communication.

With reference to FIG. 1B, an alternative assembly 10′ is schematically depicted, wherein the blades include additional/alternative features on the accessible face thereof. Aside from the alternative blades depicted in FIG. 1B, the remaining structural and functional aspects of assembly 10′ correspond to those described with reference to assembly 10 and FIG. 1A herein. Thus, with initial reference to blades 31a, 31b mounted with respect to chassis 12′, each such blade includes a power button 34′ and a floppy/disc drive 33 of known type and construction. Blade 31d includes a power button 34′, a plurality of LEDs 32′ and a jack/receptacle 35 for interaction with a plug (not pictured) or other external component. Similarly, blades 31e, 31f, 31g and 31j include jacks/receptacles 37 that are adapted to interact with a correspondingly configured plug (not pictured) or other external component. Further, blade 31h is schematically depicted with a plurality (three) jacks/receptacles 39a, 39b, 39c arranged in a side-by-side orientation along the face thereof. Each of jacks/receptacles 39a, 39b, 39c is adapted to interact with an independent plug/external component. Of note, the connections supported by the disclosed connection assemblies may facilitate copper-based communications, fiber-based communications and combinations thereof. The disclosed blade configurations of FIGS. 1A and 1B are merely illustrative and alternative blade configurations are contemplated. For example, one or more of the disclosed jacks/receptacles could be replaced with or augmented by plugs.

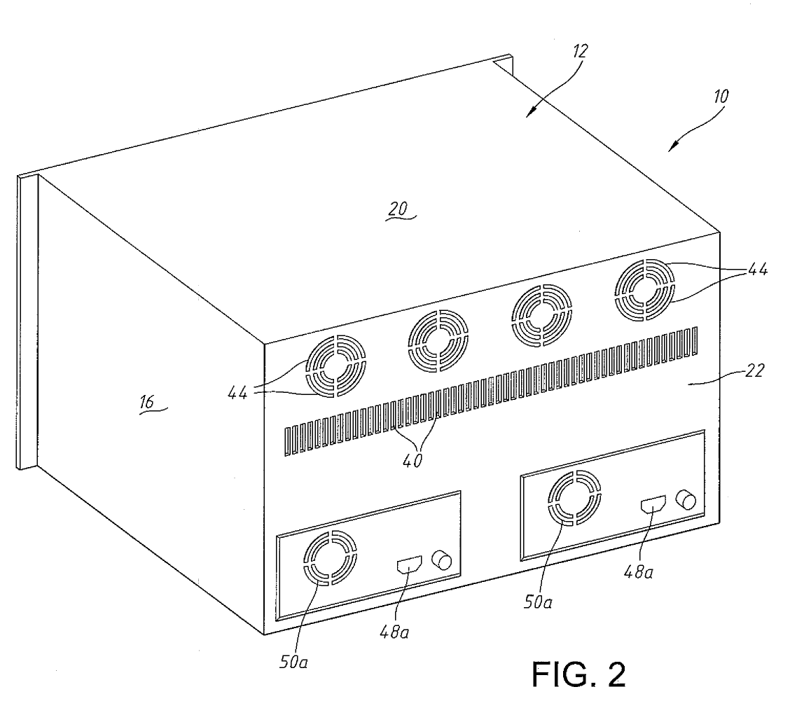

With further reference to the exemplary embodiment of FIGS. 1A and 2-4, various heat control/management features are generally associated with chassis 12. Such heat control/management features may be encompassed within chassis 12 (in whole or in part) or external thereto. Thus, for example, exemplary front face 24 includes a plurality of top and bottom vent slots 36, 38, respectively (FIG. 3). In addition and with reference to FIG. 2, rear face 22 includes a plurality of vent slots 40. Rear face 22 also advantageously supports a series of vent fans 42 that are positioned so as to exhaust heat from interior region 26 through arcuate vent openings 44 formed in rear face 22. As best seen in FIG. 3, exemplary assembly 10 includes four (4) vent fans 42 positioned in side-by-side relation along the upper edge of rear face 22. However, the present disclosure is not limited by or to a specific number or arrangement of vent fans. Rather, the present disclosure extends to chassis designs that may include one or more heat control/management features, e.g., vent fans and/or venting slots/openings, regardless of precise design, positioning or operation thereof, liquid cooling functionality, and the like.

Assembly 10 also includes power modules 46a, 46b positioned toward the rear of interior region 26 and resting on base 18. Power modules 46a, 46b are generally adapted to interact with and receive power from an ancillary power source, e.g., a wall outlet or the like. Power connection receptacles 48a, 48b are generally defined in the rear face 22 of chassis 12. Power modules 46a, 46b also typically include an internal vent fan (not pictured) that vents to the rear of chassis 12 through vent openings 50a, 50b (FIG. 2). Power modules 48a, 48b are adapted to engage and power blades 30a-30l, thereby distributing power to all blade-based components associated with assembly 10.

Backplane connectors 52 are generally mounted with respect to rear face 22 to facilitate communications and/or powering of blades 30a-30l. Thus, in exemplary embodiments of the present disclosure, backplane connectors 52 positioned within chassis 12 facilitate network-based communications, e.g., Ethernet-based communications, for respective blades. Additional communication componentry/circuitry and grounding may also be included in assembly 10 to enhance or facilitate operation thereof, as will be apparent to persons skilled in the art.

Thus, the present disclosure provides a modular blade-based server that is adapted to house blades that are pre-loaded with network-specific application software. As an example, assembly 10 could receive blades 30 that include, inter alia, a wireless controller blade, a port management blade, a spectrum analysis blade, and a RFID active tag blade. These individual applications may be developed by and/or sourced from different software companies, but the functions supported thereby would be provided in an integrated assembly with unified power/heat management and related operational integration according to the present disclosure. Moreover, the assemblies of the present disclosure support and facilitate the implementation of customer-configurable solutions. The present disclosure thus permits the repackaging of network applications in an efficient and cost-effective manner, and permits periodic updates/upgrades to network-specific applications, including transition to alternative manufacturer/supplier platforms, to be effectuated with relative ease by replacing existing blade(s) with new blade(s) as may be desired from time-to-time.

In exemplary embodiments, the disclosed assembly is 2 or 3 rack units in height, 19 inches in width and 13 inches in depth, thereby conforming to conventional rack dimensions. However, the present disclosure is not limited by or to such dimensional parameters or characteristics. Indeed, larger embodiments/implementations are expressly contemplated, e.g., on the order of seven (7) rack units in height, to accommodate additional blade-based operations. An exemplary implementation of the present disclosure includes two processor modules, two power supplies, several external exhaust fans (for cooling) and 10-12 application blades, as described herein. A backplane for communications from each blade to the processor blades is typically provided. The individual application blades would not communicate with each other. In other words, there would be no direct application-to-application communication. The individual application blades are generally approximately 1.5 inches wide, 1.5 rack units in height and 9 inches deep and incorporate appropriate hardware/software to support a specific application (or set of applications). Thus, the overall dimensional properties described above for an exemplary assembly according to the present disclosure would accommodate two (2) processor cards as well as vented space for cooling. The disclosed assembly is typically AC power based and would include or interact with one or more optional mounting brackets.

In exemplary embodiments of the present disclosure, the disclosed cooling system may include a control system for responding to temperature conditions within the interior region of the chassis. The chassis is advantageously positioned with respect to a support structure, e.g., a rack, console, cabinet, shelf and the like. The plurality of application-specific hardware modules are generally connected to a source of power and are in electronic communication with an electronic network, e.g., using Ethernet-based communication protocols. Such communication is generally achieved through appropriate cabling (e.g., copper and/or fiberoptic cabling), wireless communications or combinations thereof.

Once assembled/installed, the disclosed blade-based modular system advantageously permits individual blades to be removed and replaced by one or more application-specific hardware modules. In addition, the assembled/installed modular system may be supplemented with one or more additional application-specific hardware module (subject to space constraints). Thus, it is not necessary that the chassis be fully populated when initially assembled (or at any particular point in time), and in exemplary embodiments of the present disclosure, a chassis may be selected that permits ongoing growth/expansion in utilization over time. The application-specific hardware modules may be installed in a vertical side-by-side orientation or in a horizontally stacked orientation, based on the orientation of the associated components associated with the chassis. One or more pairs of redundant application-specific hardware modules may be included in the modular system to provide efficient back-up functionality.

The source of power for the blades positioned within the disclosed assembly may be positioned within the interior region of the chassis or exterior to the chassis. Power is supplied to the application-specific hardware modules from such power sources. In exemplary embodiments of the present disclosure, the chassis may be adapted to cooperate with a plurality of power sources.

The disclosed systems and methods advantageously marry blade server technology with application server technology in an integrated, modular assembly. The blade server technology addresses the issues of heat management, power consumption and space in the data center/telecom room for most enterprises. The application server technology addresses specific application needs of enterprises. The disclosed systems and methods take the form factor of the blade server and apply application software (e.g., wireless, NAC, RFID, Spectrum Analysis) thereto.

Although the systems and methods of the present disclosure have been described with reference to exemplary embodiments, the present disclosure is neither limited by or to such exemplary embodiments. Rather, the blade-based systems and methods of the present disclosure are susceptible to many changes, variations, modifications and/or enhancements without departing from either the spirit or scope of the present disclosure. Accordingly, the present disclosure expressly encompasses such changes, variations, modifications and/or enhancements within its scope.

1. A system for facilitating data-related operations, comprising:
a. a chassis defining an interior region;
b. a plurality of blades positioned within the chassis, at least one of the plurality of blades being programmed with application-specific software.

2. The system according to claim 1, wherein at least two of the plurality of blades are programmed with application-specific software, and wherein each of said two blades is adapted to operate independent of the other of said two blades.

3. The system according to claim 1, wherein the chassis includes at least one power module.

4. The system according to claim 1, wherein the chassis includes at least one heat control feature.

5. The system according to claim 4, wherein the heat control feature is selected from the group consisting of one or more vent fans, one or more vent slots, liquid cooling, and combinations thereof.

6. The system according to claim 1, wherein the plurality of blades are positioned in a side-by-side orientation.

7. The system according to claim 6, wherein the plurality of blades are oriented in a horizontal side-by-side orientation or a vertical side-by-side orientation.

8. The system according to claim 1, wherein the application-specific software is selected from the group consisting of wireless controller software, port management software, spectrum analysis software, and a RFID active tag software.

9. A method for facilitating electronic communications, comprising:
a. providing a chassis that is adapted to cooperate with a power source and that defines an interior region configured and dimensioned to receive a plurality of application-specific hardware modules;
b. installing a plurality of application-specific hardware modules within the chassis, wherein each of the plurality of application-specific hardware modules includes network-specific programming that is adapted to communicate with an associated end device for at least one of controlling, monitoring or managing such associated end device.

10. The method of claim 9, wherein the chassis further includes means for cooling at least a portion of the interior region of the chassis.

11. The method of claim 10, wherein the cooling means includes at least one cooling fan, a liquid cooling system or a combination thereof.

12. The method of claim 10, wherein the cooling means includes a control system for responding to temperature conditions within the interior region of the chassis.

13. The method of claim 9, further comprising positioning the chassis with respect to a support structure selected from the group consisting of a rack, console, cabinet and shelf.

14. The method of claim 9, further comprising connecting the plurality of application-specific hardware modules to a source of power.

15. The method of claim 9, further comprising establishing electronic communication between the plurality of application-specific hardware modules and an electronic network.

16. The method of claim 15, wherein the electronic communication is established at least in part through cabling.

17. The method of claim 16, wherein the electronic communication is established at least in part through wireless communication.

18. The method of claim 16, wherein the electronic communication is established at least in part based on fiberoptic communication.

19. The method of claim 9, wherein the associated end device is selected from the group consisting of access point, RFID reader, spectrum analyzer, computing device, PDA, phone, handheld communication device, barcode scanner, sensor device, camera, and combinations thereof.

20. The method of claim 9, further comprising removing and replacing at least one of said application-specific hardware modules.

21. The method of claim 9, further comprising installing at least one additional application-specific hardware module.

22. The method of claim 9, wherein the plurality of application-specific hardware modules are installed in a vertical side-by-side orientation or in a horizontally stacked orientation.

23. The method of claim 9, wherein the plurality of application-specific hardware modules includes at least one pair of redundant application-specific hardware modules.

24. The method of claim 9, wherein a source of power is positioned within the interior region of the chassis or exterior to the chassis, and the source of power communicates to application-specific hardware modules positioned within the interior region.

25. The method of claim 9, wherein the chassis is adapted to cooperate with a plurality of power sources.
